(19) United States
(12) Patent Application Publication
(10) Pub. No.: US 2011/0176393 A1
(43) Pub. Date: Jul. 21, 2011

(54) BATTERY-LESS ENVIRONMENTAL FRIENDLY QUARTZ TIMEPIECES

(75) Inventor: Shu Kwan Wong, New Territories (HK)

(73) Assignee: Ocean Works Limited, SHATIN (HK)

(21) Appl. No.: 12/531,879

(22) PCT Filed: Aug. 6, 2009
(86) PCT No.: PCT/CN2009/000893

§ 371 Date: Sep. 18, 2009

(30) Foreign Application Priority Data
Apr. 1, 2009 (CN) 200920147962.4

(51) Int. Cl. G04C 3/00

(52) U.S. Cl. 368/204

(57) ABSTRACT

This present invention discloses a quartz timepiece which can be operated without battery, which comprises an environmental-friendly electricity supply component and a quartz clock movement connected to each other, and a super capacitor serially connected to the environmental-friendly electricity supply component. The present environmental-friendly quartz timepiece operates with the super capacitor and other natural power supply unit (such as light absorbing plate and hydro-power supply device) to supply power to the timing component of the timepiece. The charge and discharge cycles of the super capacitor can reach up to a million times and are sufficient to maintain the operational life of the timepiece, and so users do not need to replace the standard battery. As a result, the timepiece is relatively simple and reasonable in structure, energy saving and environmental-friendly. The environmental-friendly quartz timepiece further provides an electricity monitoring unit in the power supply circuit. According to the light intensity of the LED indicator, users can determine the remaining electricity of the super capacitor by visual observation. It is easy to use, effective in avoiding power supply interruption and thus is safer and more reliable to operate. The light absorbing plate and the hydro-power supply device are disposed in parallel with each other and so provide enough electricity to support the alarm function and the LED back light function. It can light up the timepiece surface and the users can see the time clearly when in need.

### BACKGROUND OF THE INVENTION

The present invention relates to a timepiece and more particularly pertains to a battery-less and environmental-friendly quartz timepiece.

Common quartz timepieces are generally driven in two different ways, one is by winding manually, and the other is by batteries. Timepieces driven manually by winding do not require batteries and are thus environmental-friendly, but manual winding generate relatively little energy. Re-winding is needed every short period of time, otherwise the timepieces will stop functioning. Therefore, timepieces driven manually by winding are poor in accuracy and thus cause inconvenience to users. Timepieces driven by batteries also require replacing the batteries from time to time since the operational life of the batteries is generally shorter than that of the timepieces, and the timepieces would stop functioning if users forget to replace the batteries. Besides, used batteries are difficult to decompose in nature, therefore causes harm to the environment. There are also quartz timepieces in the prior art which are powered by accumulator batteries. The accumulator batteries are powered by light energy or kinetic energy where energy generated by movements is stored into the accumulator batteries. However, an accumulator battery generally has a short battery life and the discharge cycle is only about 500 to 1000 times, hence users still have to replace accumulator batteries from time to time. Apart from bringing inconvenience to users, the used accumulator batteries also causes harm to nature.

Therefore, the market is looking forward to a battery-less and environmental-friendly quartz timepiece which is harmless to nature, unnecessary to replace power supply regularly, environmental friendly and convenient to use.

### BRIEF SUMMARY OF THE INVENTION

In view of the aforesaid disadvantages now present in the prior art, the present invention provides a battery-less and environmental-friendly quartz timepiece which is simple and reasonable in structure, energy-saving and environmental-friendly, low in production costs, capable of real-time electricity monitoring, convenient to use and reliable to operate.

To attain this, the battery-less and environmental-friendly quartz timepiece of the present invention generally comprises an environmental-friendly electricity supply component and a quartz clock movement connected to each other, characterized in that it further comprises a super capacitor which is serially connected to the environmental-friendly electricity supply component.

More preferably, the super capacitor has a capacity of 0.1˜1.0F.

To monitor electricity, it further comprises an electricity monitoring component which is serially connected to the environmental-friendly electricity supply component. The electricity monitoring component comprises a power level LED indicator and an indicator switch, and the indicator switch and the power level LED indicator are serially connected to each other.

The quartz clock movement is an analog clock movement or a digital clock movement.

The environmental-friendly electricity supply component is either a light absorbing plate or a hydro-electricity supply device, or a light absorbing plate and a hydro-electricity supply device serially connected to each other, which supplies electricity to the same quartz clock movement. The light absorbing plate can convert either solar energy or other light energy such as light from common indoor luminous tubes, tungsten lamps and so forth into electricity. Therefore, no matter it is indoors or outdoors, sunny or cloudy, it is possible for the light absorbing plate to absorb light energy for supplying electricity. If a light absorbing plate and a hydro-electricity supply device are serially connected to each other, sufficient electricity could be provided for supporting the alarm function and the lighting of LED backlight device, so that the face of the timepiece could be lighted up for the user to see the time clearly if necessary.

The hydro-electricity supply device comprises a plurality of tap water containers, each of which has a water intake opening exposed outside the timepiece's casing and sealed with a soft plastic cover. Each tap water container forms a battery. Each tap water container is disposed with a zinc chip and a copper chip opposite to each other; the zinc chip serves as a negative electrode and the copper chip serves as a positive electrode for the battery, and electricity is generated by chemical reactions between ends of the zinc chip and the copper chip as water in the container contact the zinc chip and the copper chip; the zinc chips and the copper chips of adjacent tap water containers are interconnected by means of electric wires.

To prevent generating inverse current, a backward diode is serially connected at an end of each environmental-friendly electricity supply component.

The operating principle of the present invention is as follows: The present environmental-friendly quartz timepiece is disposed with a super capacitor which operates with the environmental-friendly electricity supply component to supply electricity to the quartz clock movement. The super capacitor is an electric double layer capacitor with the same basic principle as other types of electric double layer capacitor, that is to utilize porous activated carbon electrode and electrolyte to form a double layer structure and thereby having huge capacity. As its capacity is huge, and its outer appearance is the same as a battery, so it is also known as a “capacitor battery”. It mainly has the following characteristics:

1. Fast recharge time;

2. Small in size yet huge in capacity, the capacity being 40 times or more in comparison with electrolyte capacitor of the same size;

3. No memory effect, making it possible to recharge 1,000,000 times or more;

4. Powerful strong electric current discharge, resulting in high power density;

5. Environmental friendly and cause no pollution;

6. Simple in recharge and discharge circuit, cause no damage during overvoltage and therefore prevent maintenance;

7. Good ultra low temperature performance at −40° C.-+70° C.;

8. Convenient to monitor as the remaining power level could be observed directly.

In the present invention, the super capacitor may store electric power generated by the environmental-friendly electricity supply component in larger capacity, thereby supplying electric power to the quartz clock movement in a continuous and stable manner, and provide sufficient electric power to support alarming function and the lighting of LED backlight device, so that the face of the timepiece could be lighted up for the user to see the time clearly if necessary. On the other hand, as the remaining power level could be conveniently and directly observed or displayed, monitoring the electricity of the super capacitor is made possible by the provision of a power level LED indicator. As a result, users may determine the remaining power of the super capacitor by visually observing the light intensity of the LED indicator, thus preventing operation failure due to power run-out.

The present invention has the following advantages and effects in comparison with the prior art: The present environmental-friendly quartz timepiece operates with the super capacitor and other natural power supply unit (such as light absorbing plate and hydro-power supply device) to supply power to the timing component of the timepiece. The charge and discharge cycles of the super capacitor can reach up to a million times and are sufficient to maintain the operational life of the timepiece, and so users do not need to replace the standard battery. As a result, the timepiece is relatively simple and reasonable in structure, energy saving and environmental-friendly. The environmental-friendly quartz timepiece further provides an electricity monitoring unit in the power supply circuit. According to the light intensity of the LED indicator, users can determine the remaining electricity of the super capacitor by visual observation. It is easy to use, effective in avoiding power supply interruption and thus is safer and more reliable to operate.

### BRIEF DESCRIPTION OF THE DRAWINGS

FIG. 1 shows a front view of the first embodiment of the present invention.

FIG. 2 shows a schematic view of the circuit of the first embodiment of the present invention.

FIG. 3 shows a front view of the second embodiment of the present invention.

FIG. 4 shows a side view of the second embodiment of the present invention.

FIG. 5 shows a rear view of the second embodiment of the present invention.

FIG. 6 shows a schematic view of the circuit of the second embodiment of the present invention.

FIG. 7 shows a rear view of the third embodiment of the present invention.

FIG. 8 shows a side view of the third embodiment of the present invention.

FIG. 9 shows a front view of the fourth embodiment of the present invention.

FIG. 10 shows a side view of the fourth embodiment of the present invention.

FIG. 11 shows a rear view of the fourth embodiment of the present invention.

FIG. 12 shows a schematic view of the circuit of the fourth embodiment of the present invention.

FIG. 13 shows a schematic view of the circuit of the fifth embodiment of the present invention.

### DETAILED DESCRIPTION OF THE INVENTION

The present invention is described in detail with the embodiments and the accompanying drawings, but it is to be understood that the present invention is capable of other embodiments and of being practiced and carried out in various ways.

### Embodiment 1

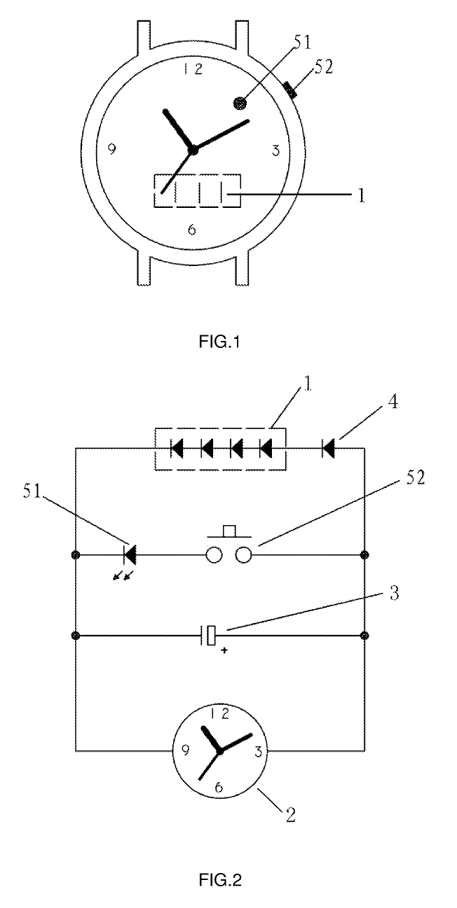

FIGS. 1 and 2 illustrate an embodiment of the present invention. As shown in FIGS. 1 and 2, the present embodiment is a watch which comprises a light absorbing plate 1 and an analog quartz clock movement 2. The model number of the analog quartz clock movement 2 is 7T35. The light absorbing plate 1 is connected with the analog quartz clock movement 2. The present embodiment further comprises a super capacitor 3 which is serially connected to the light absorbing plate 1. To prevent generating inverse current, a backward diode 4 is serially connected at an end of the light absorbing plate 1. The super capacitor 3 has a capacity of 0.1-1.0 F, depending on the power of the analog quartz clock movement 2. To monitor electricity, the present environmental-friendly quartz watch is further disposed with an electricity monitoring component which is serially connected with the light absorbing plate 1. The electricity monitoring component comprises a power level LED indicator 51 and an indicator switch 52 which are serially connected to each other. When it is necessary to know the remaining power level, the user only has to press the indicator switch 52. The power level LED indicator 51 is then lighted up according to the current magnitude in the circuit. A stronger light intensity indicates stronger current, and a weaker light intensity indicates weaker current. If the light intensity is very weak, it is indicated that the power is almost running out and it is necessary to take suitable measures (e.g. increase lighting intensity or lengthen lighting time) to increase power storage. In other embodiments, the analog quartz clock movement 2 may be replaced with a digital clock movement which comprises main control IC, LED display and other components.

### Embodiment 2

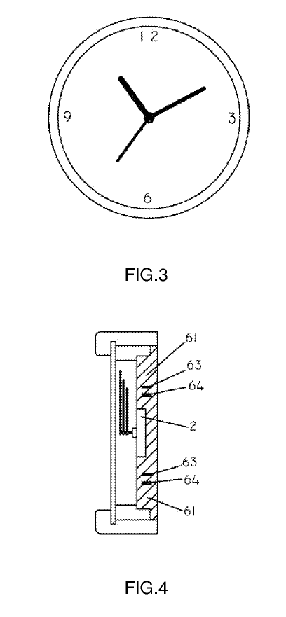

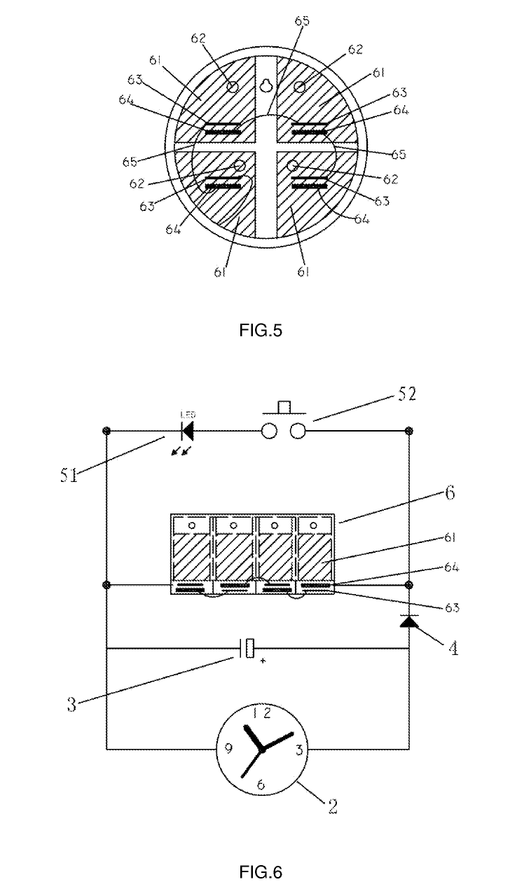

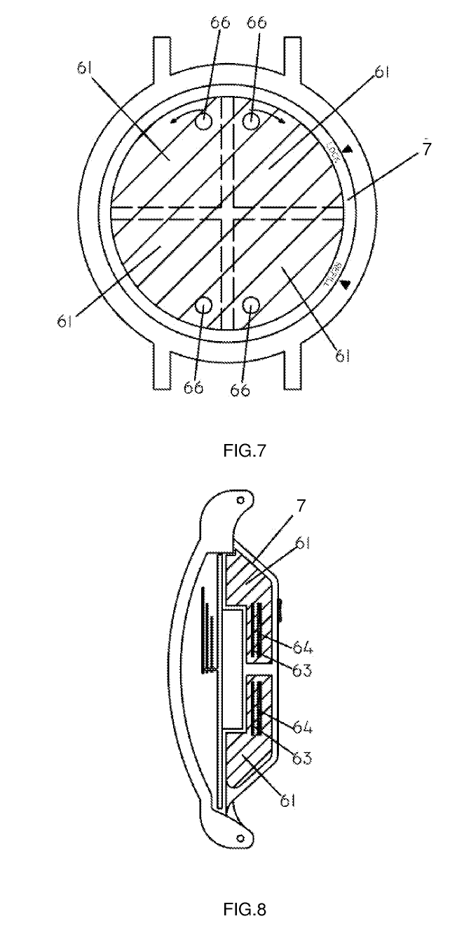

FIGS. 3-6 illustrate another embodiment of the present invention. As shown in FIGS. 3-6, the present embodiment is a wall clock which comprises a hydro-electricity supply device 6 and an analog quartz clock movement 2. The hydro-electricity supply device 6 and the analog quartz clock movement 2 are connected to each other. The present embodiment further comprises a super capacitor 3 which is serially connected to the hydro-electricity supply device 6. To prevent generating inverse current, a backward diode 4 is serially connected at an end of the hydro-electricity supply device 6. The super capacitor 3 has a capacity of 0.1-1.0 F, depending on the power of the analog quartz clock movement 2. The hydro-electricity supply device 6 comprises a plurality of tap water containers 61 disposed at the back of the wall clock. Each of the tap water containers 61 has a water intake opening exposed outside the casing of the wall clock and sealed with a soft plastic cover 62. Each tap water container 61 forms a battery. Each tap water container 61 is disposed with a zinc chip 63 and a copper chip 64 opposite to each other. The zinc chip 63 serves as a negative electrode and the copper chip 64 serves as a positive electrode for the battery, and electricity is generated by chemical reactions between ends of the zinc chip 63 and the copper chip 64 as water in the container contact the zinc chip 63 and the copper chip 64. The zinc chips 63 and the copper chips 64 of adjacent tap water containers 61 are interconnected by means of electric wires 65. To monitor electricity, the present embodiment is further disposed with an electricity monitoring component which is serially connected with the hydro-electricity supply device 6. The electricity monitoring component comprises a power level LED indicator 51 and an indicator switch 52 which are serially connected to each other. When it is necessary to know the remaining power level, the user only has to press the indicator switch 52. The power level LED indicator 51 is then lighted up according to the current magnitude in the circuit. A stronger light intensity indicates stronger current, and a weaker light intensity indicates weaker current. If the light intensity is very weak, it is indicated that the power is almost running out and it is necessary to take suitable measures (e.g. adding water to the tap water containers) to increase power storage.

### Embodiment 3

FIGS. 7-8 illustrate another embodiment of the present invention. As shown in FIGS. 7-8, the present embodiment is a watch which has the same characteristics as those of Embodiment 2 except for the following: The hydro-electricity supply device 6 comprises a plurality of tap water containers 61 disposed at the back of the watch. Each of the tap water containers 61 has a water intake opening 66 exposed outside the casing of the watch. The water intake openings 66 of the four tap water containers 61 are sealed by a circular plate 7. When the circular plate 7 is rotated to a position where its opening and the water intake opening 66 overlap with each other, user may add tap water to the water intake opening 66 via the opening of the circular plate.

### Embodiment 4

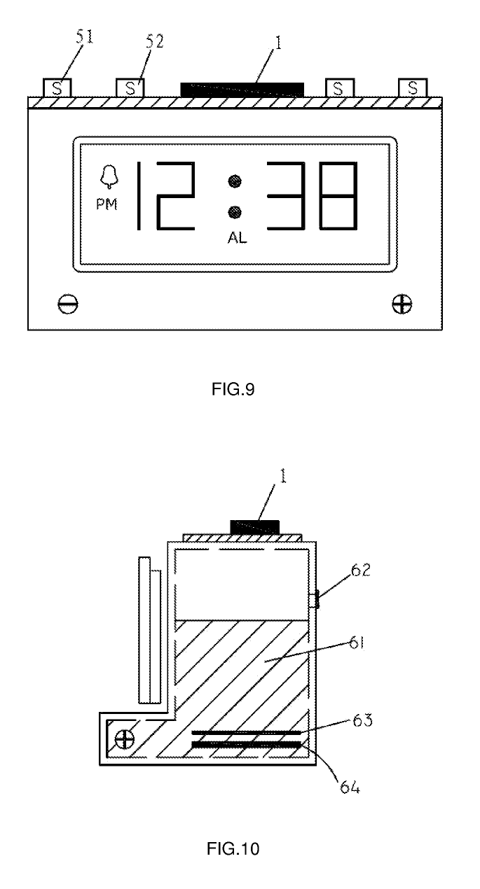

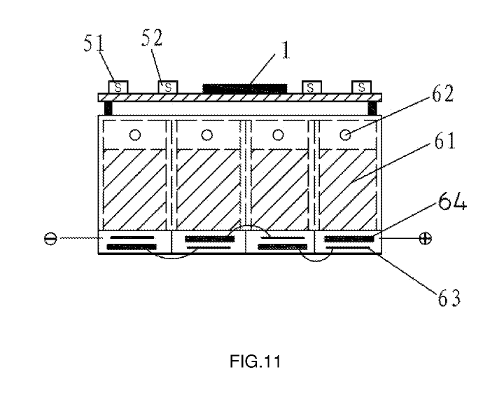

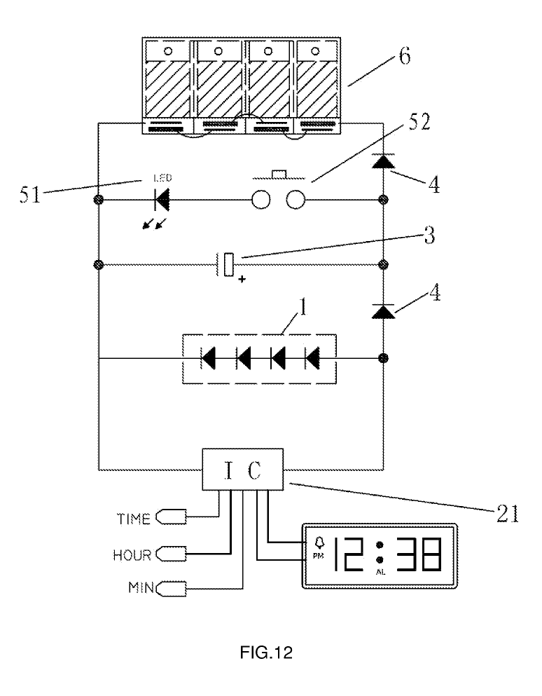

FIGS. 9-12 illustrate another embodiment of the present invention. As shown in FIGS. 9-12, the present embodiment is a digital alarm clock which comprises a light absorbing plate 1, a hydro-electricity supply device 6 and a digital clock movement 21. The light absorbing plate 1 and the hydro-electricity supply device 6 and both serially connected with the digital clock movement 21 respectively. The present embodiment further comprise a super capacitor 3 which is serially connected with the light absorbing plate 1 and the hydro-electricity supply device 6. The super capacitor 3 has a capacity of 0.1-1.0 F, depending on the power of the digital clock movement 21. In this embodiment, the light absorbing plate 1 and the hydro-electricity supply device 6 are both serially disposed to provide sufficient electrical power to support alarming function and the lighting of LED backlight device, so that the face of the timepiece could be lighted up for the user to see the time clearly if necessary. The hydro-electricity supply device 6 comprises a plurality of tap water containers 61 disposed at the back of the clock. Each of the tap water containers 61 has a water intake opening exposed outside the casing of the wall clock and sealed with a soft plastic cover 62. Each tap water container 61 forms a battery. Each tap water container 61 is disposed with a zinc chip 63 and a copper chip 64 opposite to each other. The zinc chip 63 serves as a negative electrode and the copper chip 64 serves as a positive electrode for the battery, and electricity is generated by chemical reactions between ends of the zinc chip 63 and the copper chip 64 as water in the container contact the zinc chip 63 and the copper chip 64. The zinc chips 63 and the copper chips 64 of adjacent tap water containers 61 are interconnected by means of electric wires 65. To prevent generating inverse current, a backward diode 4 is serially connected at an end of each of the light absorbing plate 1 and the hydro-electricity supply device 6. To monitor electricity, the present embodiment is further disposed with an electricity monitoring component which is serially connected with the light absorbing plate 1 and the hydro-electricity supply device 6. The electricity monitoring component comprises a power level LED indicator 51 and an indicator switch 52 which are serially connected to each other. When it is necessary to know the remaining power level, the user only has to press the indicator switch 52. The power level LED indicator 51 is then lighted up according to the current magnitude in the circuit. A stronger light intensity indicates stronger current, and a weaker light intensity indicates weaker current. If the light intensity is very weak, it is indicated that the power is almost running out and it is necessary to take suitable measures (e.g. adding water to the tap water containers, increase lighting intensity or lengthen lighting time) to increase power storage. In other embodiments, the digital clock movement 21 may be replaced with an analog quartz alarm clock movement.

### Embodiment 5

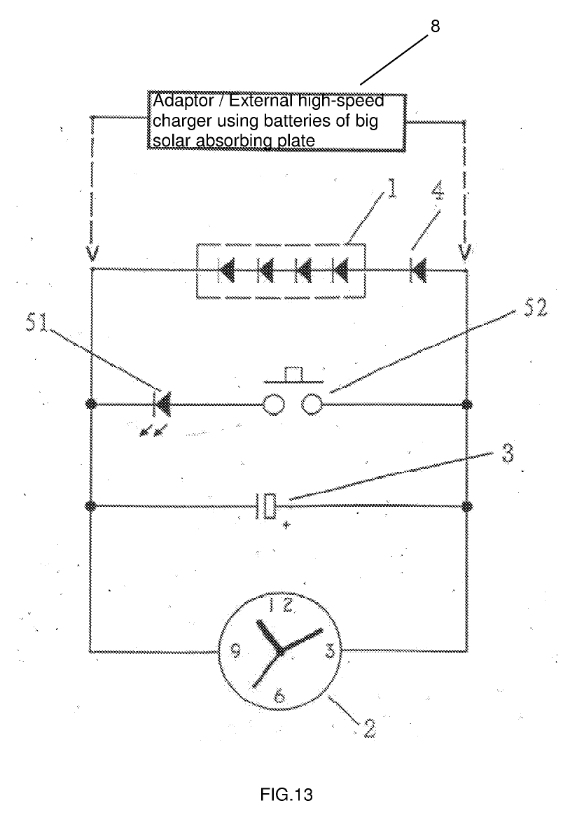

FIG. 13 illustrates a further embodiment of the present invention. As shown in FIG. 13, the present embodiment is a watch which comprises a light absorbing plate 1 and an analog quartz clock movement 2 which are connected with each other. The present embodiment further comprises a super capacitor 3 which is serially connected with the light absorbing plate 1. To prevent generating inverse current, a backward diode 4 is serially connected at an end of the light absorbing plate 1. The super capacitor 3 has a capacity of 0.1-1.0 F, depending on the power of the analog quartz clock movement 2. To monitor electricity, the present embodiment is further disposed with an electricity monitoring component which is serially connected with the light absorbing plate 1. The electricity monitoring component comprises a power level LED indicator 51 and an indicator switch 52 which are serially connected to each other. When it is necessary to know the remaining power level, the user only has to press the indicator switch 52. The power level LED indicator 51 is then lighted up according to the current magnitude in the circuit. A stronger light intensity indicates stronger current, and a weaker light intensity indicates weaker current. If the light intensity is very weak, it is indicated that the power is almost running out and it is necessary to take suitable measures (e.g. increase lighting intensity or lengthen lighting time) to increase power storage. The present embodiment further comprises a recharge terminal 8 which is connected externally to a high-speed charger or a converter of an electricity source. The present embodiment has the following advantages: if the present embodiment is stored in a locker and has not been used for a long time nor exposed under any light source for the light absorbing plate to recharge, relying only on the light absorbing plate disposed on the quartz watch to recharge the super capacitor would take a long time due to the limited size of the light absorbing plate. Therefore, the present embodiment provides a recharge terminal for the user to recharge via external high-speed charger or electricity source. A high-speed charger could be a charger supported by dry batteries or a light energy charger disposed with a light absorbing plate having a relatively large surface area. To recharge via an external electricity source, a converter could be provided between the electricity source and the recharge terminal for voltage adjustment. The aforementioned high-speed charger and converter are prior art and thus are not elaborated further herein. Certainly, even if the present embodiment is not disposed with a super capacitor but normal recharge batteries, the present invention may achieve the aforementioned advantages.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

1. A battery-less and environmental-friendly quartz timepiece which comprises an environmental-friendly electricity supply component and a quartz clock movement connected to each other, characterized in that it further comprises an electricity storage component which is serially connected to the environmental-friendly electricity supply component.

2. The battery-less and environmental-friendly quartz timepiece as in claim 1, wherein it further comprises a recharge terminal which is connected externally to a high-speed charger or a converter of an electricity source for supplying electricity to the electricity storage component.

3. The battery-less and environmental-friendly quartz timepiece as in claim 2, wherein the high-speed charger is a charger supported by dry batteries or is a light energy charger disposed with a light absorbing plate having a relatively large surface area for absorbing light energy.

4. The battery-less and environmental-friendly quartz timepiece as in claim 1, wherein the electricity storage component is a super capacitor or a rechargeable battery.

5. The battery-less and environmental-friendly quartz timepiece as in claim 4, wherein the super capacitor has a capacity of 0.1˜1.0F.

6. The battery-less and environmental-friendly quartz timepiece as in claim 1, wherein it further comprises an electricity monitoring component which is serially connected to the environmental-friendly electricity supply component, and the electricity monitoring component comprises a power level LED indicator and an indicator switch, and the indicator switch and the power level LED indicator are serially connected to each other.

7. The battery-less and environmental-friendly quartz timepiece as in claim 1, wherein the quartz clock movement is a digital clock movement or an analog clock movement.

8. The battery-less and environmental-friendly quartz timepiece as in claim 1, wherein the environmental-friendly electricity supply component is a light absorbing plate.

9. The battery-less and environmental-friendly quartz timepiece as in claim 1, wherein the environmental-friendly electricity supply component is a hydro-electricity supply device.

10. The battery-less and environmental-friendly quartz timepiece as in claim 1, wherein the environmental-friendly electricity supply component comprises a light absorbing plate and a hydro-electricity supply device which are serially connected to each other.

11. The battery-less and environmental-friendly quartz timepiece as in any of claims 9-10, wherein the hydro-electricity supply device comprises a plurality of tap water containers, each of which has a water intake opening exposed outside the timepiece's casing and sealed with a soft plastic cover; each tap water container forms a battery; each tap water container is disposed with a zinc chip and a copper chip opposite to each other; the zinc chip serves as a negative electrode and the copper chip serves as a positive electrode for the battery, and electricity is generated by chemical reactions between ends of the zinc chip and the copper chip as water in the container contact the zinc chip and the copper chip; the zinc chips and the copper chips of adjacent tap water containers are interconnected by means of electric wires.
